(19) United States
(12) Patent Application Publication
(10) Pub. No.: US 2015/0381716 A1
(43) Pub. Date: Dec. 31, 2015

(54) METHOD AND SYSTEM FOR SHARING FILES OVER P2P

(71) Applicant: MYDRIVES, Inc., Yuseong-gu (KR)

(72) Inventor: Sung Soo MOON, Bucheon-si (KR)

(21) Appl. No.: 14/335,152

(22) Filed: Jul. 18, 2014

(30) Foreign Application Priority Data
Jun. 25, 2014 (KR) 10-2014-0078297

(51) Int. Cl. H04L 29/08; H04L 12/58; H04L 29/06

(52) U.S. Cl. CPC H04L 67/104; H04L 65/403; H04L 67/141; H04L 51/32; H04L 63/0428; H04L 63/061

(57) ABSTRACT

A method of sharing files over Peer-to-Peer (P2P) is provided. The method includes transmitting, at a transmitter terminal, sharing registration information for sharing at least one file with another terminal, receiving, at the transmitter terminal, a virtual link as a response to the sharing registration information, sharing, at the transmitter terminal, the virtual link, receiving, at the transmitter terminal, a sharing request signal from a receiver terminal accessing the transmitter terminal via the virtual link and transmitting, at the transmitter terminal, the at least one file to the receiver terminal as a response to the sharing request signal.

### CROSS REFERENCE TO RELATED APPLICATIONS

This application claims priority to Korean Patent Application No. 10-2014-0078297 filed on Jun. 25, 2014 in the Korean Intellectual Property Office, the disclosure of which is incorporated herein by reference in its entirety.

### BACKGROUND

1. Field of the Invention

The invention relates to a method and system for sharing files over Peer-to-Peer (P2P), and more particularly, to a method of sharing files over P2P, in which files can be shared over P2P through the mediation of a server, and a system for sharing files over P2P, using the method.

2. Description of the Related Art

As the acquisition of information through the internet and the sharing of data become common and widespread, Peer-to-Peer (P2P) services, which allow individuals to be connected to one another and thus to share data between them, have been developed, facilitating data sharing. P2P services not only simply enable the sharing of data, but also allow personal computers (PCs) to be connected to one another and search through and share each other's data, thereby making all the users connected become suppliers, and at the same time, consumers of data.

P2P services are largely classified into two models, i.e., a hybrid P2P model in which data suppliers and data receivers are both connected to a server as peers, data to be shared is collected by the server, and the peers can access each other by acquiring information relating to data suppliers with the data to be shared from the server, and a pure P2P model in which peers share in advance addresses for sharing data, for example, Internet Protocol (IP) addresses, and can access each other by using the shared addresses without the mediation of a server.

Hybrid- or pure-P2P data sharing requires both data suppliers and data receivers to use particular exclusive applications for data transmission or reception over P2P. However, the sharing of files through such exclusive applications causes inconvenience because of all the hassle of installing and executing the exclusive applications and sending or receiving files through the exclusive applications only.

Files can often be shared through an email system or a web hard system. However, due to the limited service capability of an email server or a web hard system server, large files may not become sharable unless they are segmented into smaller files.

Therefore, there are heightened expectations for the development of a method and system for sharing files over P2P, which are capable of facilitating the sharing of files without a requirement of the use of particular applications and enabling the sharing of large files while strengthening the advantages of existing P2P services.

### SUMMARY

Exemplary embodiments of the invention provide a method of sharing files over Peer-to-Peer (P2P), which uses Hyper-Text Transfer Protocol (HTTP) to share large files over P2P.

Exemplary embodiments of the invention also provide a system for sharing files over P2P, which uses HTTP to share large files over P2P.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to the exemplary embodiments of the invention, an exclusive application for P2P data sharing is installed only in a transmitter terminal, and a receiver terminal can share files from the transmitter terminal simply by using a web browser.

Other features and exemplary embodiments will be apparent from the following detailed description, the drawings, and the claims.

### BRIEF DESCRIPTION OF THE DRAWINGS

FIG. 1 is a block diagram of a system for sharing files over Peer-to-Peer (P2P), according to an exemplary embodiment of the invention.

FIG. 2 is a block diagram of a transmitter terminal according to an exemplary embodiment of the invention.

FIG. 3 is a diagram illustrating a sharing information storage unit according to an exemplary embodiment of the invention.

FIG. 4 is a diagram illustrating the configuration of sharing registration information according to an exemplary embodiment of the invention.

FIG. 5 is a flowchart illustrating the operation of a transmitter terminal, according to an exemplary embodiment of the invention.

FIG. 6 is a block diagram of a sharing server according to an exemplary embodiment of the invention.

FIG. 7 is a diagram illustrating a sharing registration storage unit according to an exemplary embodiment of the invention.

FIG. 8 is a diagram illustrating a virtual link and a real link according to an exemplary embodiment of the invention.

FIG. 9 is a flowchart illustrating the operation of a sharing server, according to an exemplary embodiment of the invention.

FIG. 10 is a block diagram of a receiver terminal according to an exemplary embodiment of the invention.

FIG. 11 is a flowchart illustrating the operation of a receiver terminal, according to an exemplary embodiment of the invention.

FIG. 12 is a signal flowchart illustrating the transmission of signals or messages between the transmitter terminal, the sharing server and the receiver terminal of a system for sharing files over Peer-to-Peer (P2P), according to an exemplary embodiment of the invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

FIG. 1 is a block diagram of a system for sharing files over Peer-to-Peer (P2P), according to an exemplary embodiment of the invention.

A system 500 for sharing files over Peer-to-Peer (P2P), according to an exemplary embodiment of the invention will hereinafter be described with reference to FIG. 1.

Referring to FIG. 1, the system 500, which uses a method of sharing files over P2P, according to an exemplary embodiment of the invention, may include a transmitter terminal 100, a sharing server 200 and a receiver terminal 300.

The transmitter terminal 100 is a terminal that stores files to be shared and shares the files with other terminals.

For example, the transmitter terminal 100 may be a personal computer (PC), a smart phone, a tablet or a smart device, but the invention is not limited thereto.

The transmitter terminal 100 receives a sharing request signal for a predetermined file from a user thereof and registers the predetermined file in the sharing server 200 as a file to be shared. In response to receipt of a sharing request for the predetermined file from the receiver terminal 300, the transmitter terminal 100 transmits the predetermined file to the receiver terminal 300.

In response to the registration of the predetermined file in the sharing server 200 as a file to be shared being complete, the transmitter terminal 100 may receive (20) a virtual link from the sharing server 200.

The transmitter terminal 100 may share (60) the virtual link with a terminal that the transmitter terminal 100 is to share the predetermined file with. For convenience, it is assumed that the receiver terminal 300 is the terminal that the transmitter terminal 100 is to share the predetermined file with.

In response to receipt of a sharing request signal for the predetermined file from the receiver terminal 300, the transmitter terminal 100 may transmit (60) the predetermined file to the receiver terminal 300.

The sharing server 200 may maintain and manage sharing registration information for one or more files to be shared from the transmitter terminal 100. The sharing server 200 may engage in a sharing process between the transmitter terminal 100 and the receiver terminal 300 by allowing the receiver terminal 100, which requests the predetermined file, to access the transmitter terminal 100 and share the predetermined file based on the sharing registration information.

The sharing server 200 may receive sharing registration information relating to the predetermined file from the transmitter terminal 100. The sharing server 200 may store the received sharing registration information. The sharing server 200 may receive updated sharing registration information from the transmitter terminal 100 and may update existing sharing registration information based on the received updated sharing registration information.

The sharing server 200 may generate a virtual link for sharing the predetermined file based on the sharing registration information relating to the predetermined file. The virtual link may be a virtual address link to the predetermined file. The transmitter terminal 100 may receive the virtual link from the sharing server 200, and may share the virtual link with the receiver terminal 300 that wishes to share the predetermined file. By using the virtual link, instead of an actual physical address of the predetermined file, the predetermined file may be shared between the transmitter terminal 100 and the receiver terminal 300, and as a result, security may be improved.

In response to the receiver terminal 300 accessing (30) the sharing server 200 using the virtual link, the sharing server 200 may redirect the receiver terminal 300's access thereto to the transmitter terminal 100 so that the receiver terminal 300 can access the transmitter terminal 100.

To allow the receiver terminal 300 to access the transmitter terminal 100, the sharing server 200 may access the transmitter terminal 100 and may thus generate a real link via which the predetermined file can be acquired. In response to receipt of a request for the transmission of a file corresponding to the virtual link from the receiver terminal 300, the sharing server 200 may transmit (40) redirection information including the real link to the receiver terminal 300.

The receiver terminal 300 may share the predetermined file present in the transmitter terminal 100 via the virtual link.

The receiver terminal 300 may access the sharing server 200 via the virtual link, and may receive the redirection information from the sharing server 200.

In response to receipt of the redirection information from the sharing server 200, the receiver terminal 300 may access the transmitter terminal 100 via the real link included in the redirection information, and may share the predetermined file from the transmitter terminal 100.

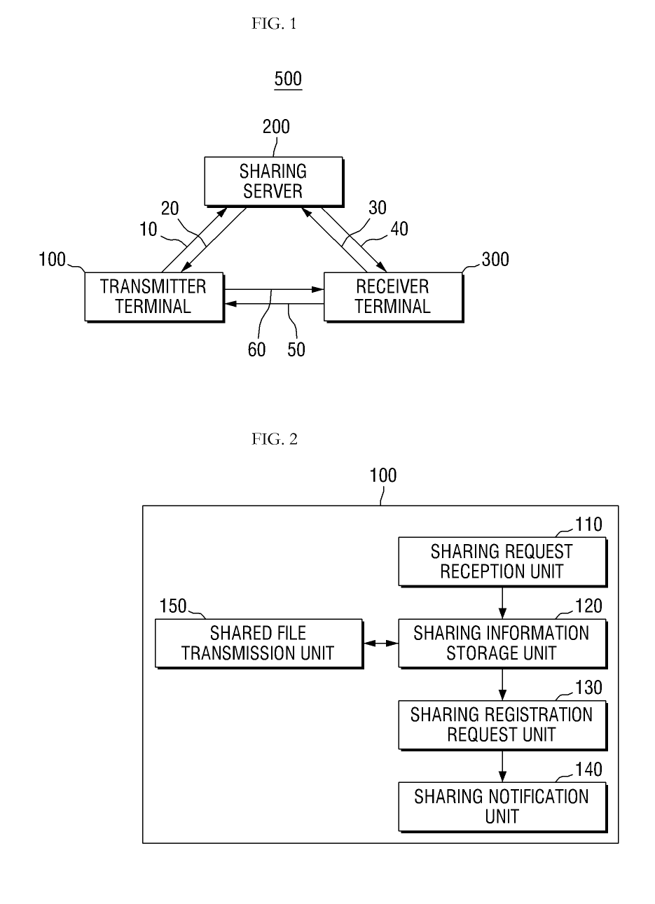

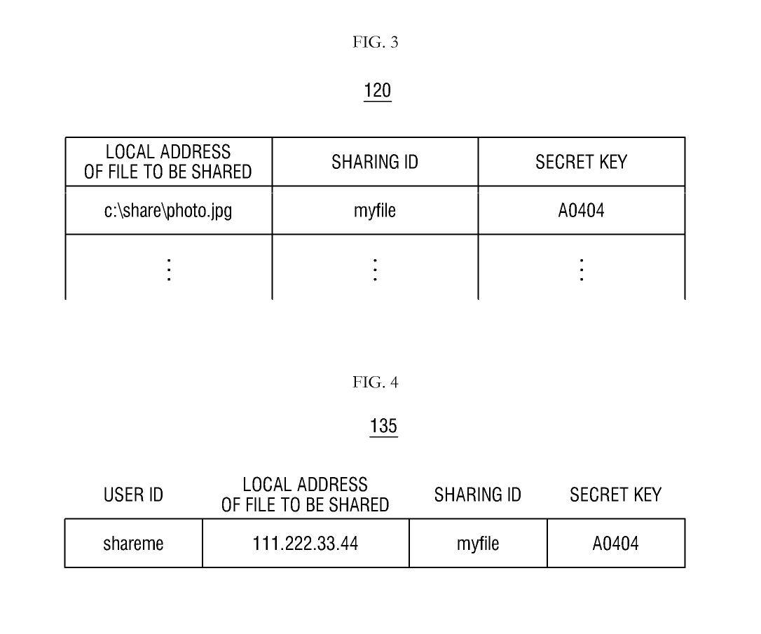

FIG. 2 is a block diagram of a transmitter terminal according to an exemplary embodiment of the invention.

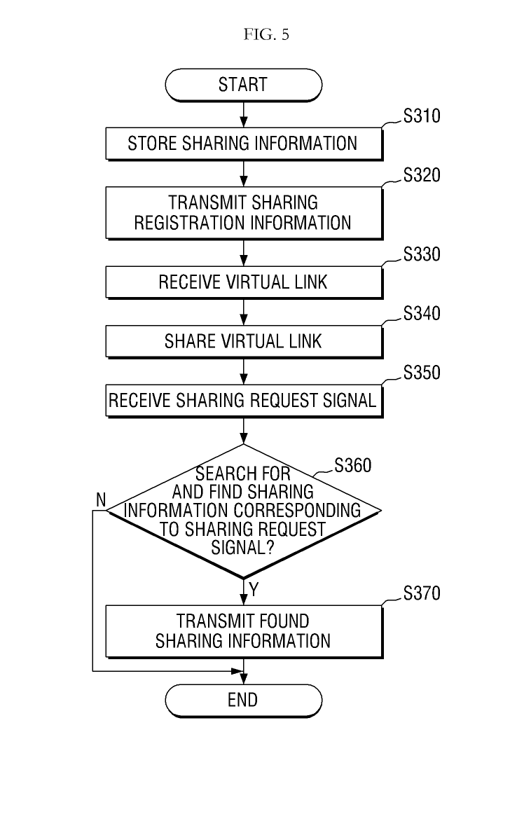

FIG. 3 is a diagram illustrating a sharing information storage unit according to an exemplary embodiment of the invention.

FIG. 4 is a diagram illustrating the configuration of sharing registration information according to an exemplary embodiment of the invention.

The structure and operation of a transmitter terminal according to an exemplary embodiment of the invention will hereinafter be described with reference to FIGS. 2 to 4.

Referring to FIG. 2, the transmitter terminal 100 may include a sharing request reception unit 110, a sharing information storage unit 120, a sharing registration request unit 130, a sharing notification unit 140 and a shared file transmission unit 150.

The sharing request reception unit 110 may receive a sharing request for a predetermined file from a user of the transmitter terminal 100. The sharing request may include a local address of the predetermined file and a sharing ID corresponding to the predetermined file. The sharing ID may include a string of text by which the predetermined file can be identified.

For example, the user of the transmitter terminal 100 may choose the predetermined file from a file list including one or more files to be shared, and may be provided with a user interface (UI) for entering a sharing ID. In response to the user of the transmitter terminal 100 entering a sharing ID corresponding to the predetermined file into the UI, the sharing request reception unit 110 may receive the local address and the entered file name of the predetermined file.

The sharing information storage unit 120 may store sharing information, including the local address and the sharing ID of the predetermined file, provided by the sharing request reception unit 110.

The sharing information may also include a secret key that is needed to authenticate a request for the predetermined file. The secret key may be a value set in advance for all files to be shared or a value set later only for the predetermined file.

The sharing information storage unit 120 may store the sharing information in the form of a table. FIG. 3 illustrates an example of a table in which to share the sharing information. Referring to FIG. 3, the sharing information may be stored in the form of a table listing a local address “C:\share\photo.jpg”, a sharing ID “myfile” and a secret key “A0404”.

The sharing registration request unit 130 may send a sharing registration request for the predetermined file by transmitting sharing registration information relating to the predetermined file to the sharing server 200. In response to the registration of the predetermined file as a file to be shared being complete, the receiver terminal 300 may access the transmitter terminal 100 via the sharing server 200 and may thus be provided with the predetermined file.

The sharing registration information may include a user identifier (ID) of the transmitter terminal 100, a sharing ID, an Internet Protocol (IP) address of the transmitter terminal 100 and a secret key. The user ID may be an ID by which the user of the transmitter terminal 100 can be identified. The sharing ID may include a string of text by which the predetermined file can be identified, and may be used to identify the predetermined file. The IP address may be an address allocated to the transmitter terminal 100 on the Internet. The secret key may be a value for authenticating a request for the predetermined file.

FIG. 4 illustrates an example of the sharing registration information, i.e., sharing registration information 135. Referring to FIG. 4, the sharing registration information 135 may include, and sequentially list, a user ID, the IP address of the transmitter terminal 100, a sharing ID and a secret key, but the invention is not limited thereto.

The sharing registration request unit 130 may receive a virtual link from the sharing server as a response to the sharing registration information. The virtual link may be a link for sharing the predetermined file with other terminals. The predetermined file may be shared to other terminals via the virtual link.

The sharing registration request unit 130 may provide the virtual link to the sharing notification unit 140.

The sharing notification unit 140 may receive the virtual link and may share the virtual link with the receiver terminal 300. The virtual link may be shared to the receiver terminal 300 via one of a Social Network Service (SNS) and a messaging service, but the invention is not limited thereto.

The sharing notification unit 140 may share the virtual link with the receiver terminal 300 via a wired or wireless network. Examples of the wired network include an Ethernet. Examples of the wireless network include a Third Generation (3G), Fourth Generation (4G), Long Term Evolution (LTE), LTE-Advanced (LTE-A), Wireless Fidelity (WiFi) or Bluetooth network.

The shared file transmission unit 150 may receive a transmission request signal for the predetermined file from the receiver terminal 300. The shared file transmission unit 150 may transmit a file corresponding to the received transmission request signal to the receiver terminal 300.

The received transmission request signal may be encrypted with a secret key. The shared file transmission unit 150 may decrypt the received transmission request signal. The decrypted transmission request signal may include a sharing ID.

The shared file transmission unit 150 may search the sharing information storage unit 120 for information relating to a file corresponding to the sharing ID included in the decrypted transmission request signal. The information relating to the file corresponding to the sharing ID included in the decrypted transmission request signal may be the local address of the predetermined file. In response to a match for the sharing ID included in the decrypted transmission request signal, i.e., the local address of the predetermined file, being found from the sharing information storage unit 120, the shared file transmission unit 150 may transmit the predetermined file to the receiver terminal 300.

On the other hand, in response to no match for the sharing ID included in the decrypted transmission request signal being found from the sharing information storage unit 120, the shared file transmission unit 150 may determine the received transmission request signal as being invalid, and may transmit an error message or a warning message to the receiver terminal 300.

FIG. 5 is a flowchart illustrating the operation of a transmitter terminal, according to an exemplary embodiment of the invention.

The operation of the transmitter terminal 100 will hereinafter be described with reference to FIG. 5.

Referring to FIG. 5, the transmitter terminal 100 receives a sharing request for a predetermined file from the user thereof, and stores (S310) sharing information included in the received sharing request. The sharing information may include a local address and a sharing ID of the predetermined file and a secret key.

The transmitter terminal 100 transmits (S320) sharing registration information for sharing the predetermined file with other terminals. The sharing registration information may include the user ID and the IP address of the transmitter terminal 100, the sharing ID of the predetermined file, and the secret key.

The transmitter terminal 100 receives (S330) a virtual link as a response to the sharing registration information. The virtual link may be a virtual address at which the predetermined file can be shared to other terminals.

The transmitter terminal 100 shares (S340) the virtual link with other terminals. More specifically, the transmitter terminal 100 may share the virtual link, instead of the predetermined file, with other terminals such that the predetermined file can be shared to the other terminals through the virtual link, rather than directly.

The transmitter terminal 100 receives (S350) a sharing request signal for the predetermined signal.

The transmitter terminal 100 searches for (S360) information relating to the predetermined file from the sharing information stored in S310.

In response to a match for the predetermined file being found, the transmitter terminal 100 transmits (S370) the predetermined file as a response to the received sharing request signal.

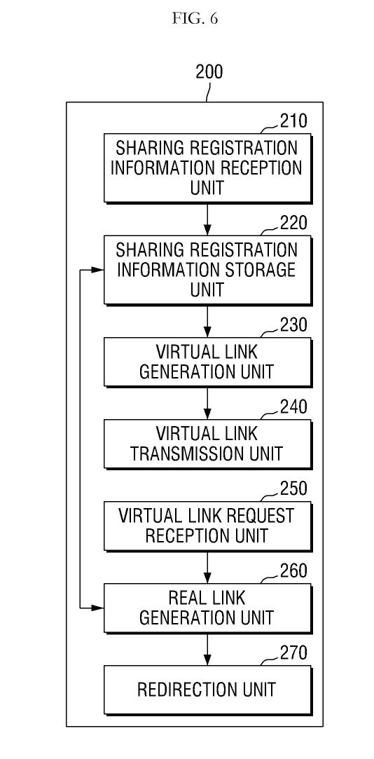

FIG. 6 is a block diagram of a sharing server according to an exemplary embodiment of the invention.

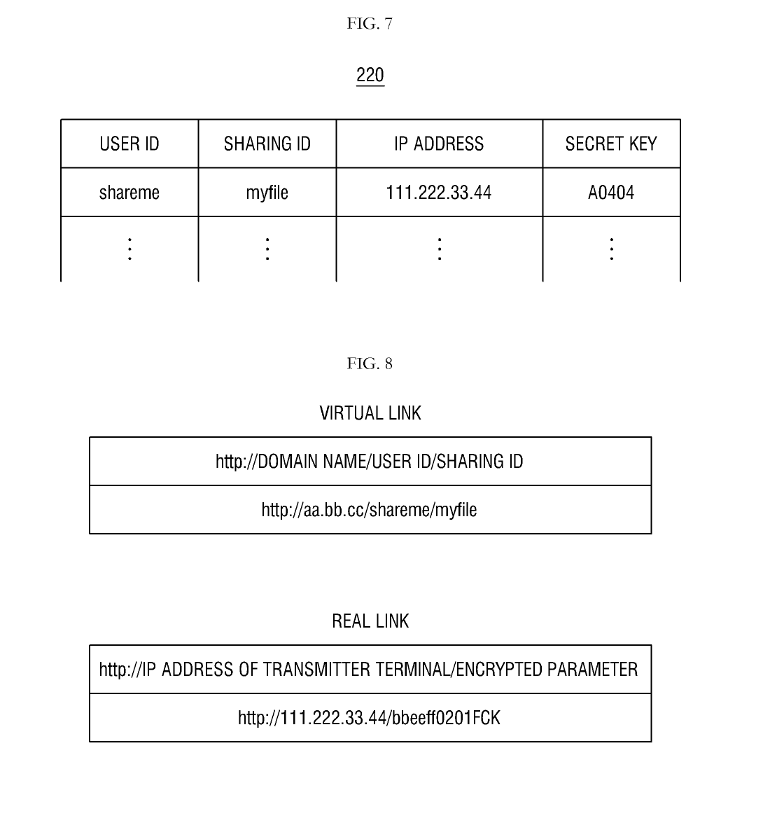

FIG. 7 is a diagram illustrating a sharing registration storage unit according to an exemplary embodiment of the invention.

FIG. 8 is a diagram illustrating a virtual link and a real link according to an exemplary embodiment of the invention.

The structure and operation of the sharing server 200 will hereinafter be described with reference to FIGS. 6 to 8.

Referring to FIG. 6, the sharing server 200 may include a sharing registration information reception unit 210, a sharing registration information storage unit 220, a virtual link generation unit 230, a virtual link transmission unit 240, a virtual link request reception unit 250, a real link generation unit 260 and a redirection unit 270.

The sharing registration information reception unit 210 may receive sharing registration information from the transmitter terminal 100. The sharing registration information may include the user ID and the IP address of the transmitter terminal 100, a sharing ID of a predetermined file to be shared, and a secret key.

The sharing registration information storage unit 220 may store the sharing registration information received by the sharing registration information reception unit 210.

For example, referring to FIG. 7, the sharing registration information storage unit 220 may store the sharing registration information in the form of a table.

The virtual link generation unit 230 may generate a virtual link based on the sharing registration information. The virtual link may be a virtual address link to a file corresponding to the sharing registration information, i.e., the predetermined file.

In an exemplary embodiment, the virtual link generation unit 230 may generate a domain name by combining arbitrary text strings, and may store the domain name and the IP address of the sharing server 200 in a domain name service (DNS) server (not illustrated). The virtual link generation unit 230 may generate the virtual link in a Hyper-Text Transfer Protocol (HTTP) format by combining the user ID and the sharing ID included in the sharing registration information and the domain name.

For example, referring to FIG. 8, the virtual link generation unit 230 may generate the virtual link in an “http://domain name/user ID/sharing ID” format. In response to the domain name, the user ID of the transmitter terminal 100 and the sharing ID of the predetermined file being “aa.bb.cc”, “shareme” and “myfile”, respectively, the virtual link generation unit 230 may generate “http://aa.bb.cc/shareme/myfile” as a virtual link

The external address of the virtual link, which is generated by the virtual link generation unit 230, may indicate the IP address of the sharing server 200 due to the DNS server, and the internal address of the virtual link may include the user ID of the transmitter terminal 100 and the sharing ID of a file to be shared. Accordingly, a request for a file corresponding to the generated virtual link may be transmitted to the sharing server 200, and the sharing server 200 may redirect the request to the address of the transmitter terminal 100 where the file to be shared is actually located based on the internal address of the virtual link with the aid of the sharing registration information storage unit 220.

The virtual link transmission unit 240 may transmit the virtual link as a response to the sharing registration information.

In an exemplary embodiment, the virtual link transmission unit 240 may transmit the virtual link to the transmitter terminal 100. The transmitter terminal 100 may receive the virtual link, and may use the virtual link to share the predetermined file.

The virtual link request reception unit 250 may receive an access request via the virtual link.

In an exemplary embodiment, the virtual link may be an address link in the HTTP format. The virtual link request reception unit 250 may receive an HTTP access request via the virtual link. In response to receipt of an HTTP access request via the virtual link, the virtual link request reception unit 250 may extract an internal path included in the received HTTP access request. For example, in response to the received HTTP access request being “http://aa.bb.cc/shareme/myfile”, the virtual link request reception unit 250 may extract “shareme/myfile” as an internal path. The virtual link request reception unit 250 may provide the extracted internal path to the real link generation unit 260.

The real link generation unit 260 may access a terminal having the predetermined file and may generate a real link via which the predetermined file can be shared.

The real link generation unit 260 may search for and find information relating to the access request signal received by the virtual link request reception unit 250 from the sharing registration information storage unit 220, and may generate a real link based on the found information.

In an exemplary embodiment, the real link generation unit 260 may search for sharing registration information corresponding to the internal path provided by the virtual link request reception unit 250 from the sharing registration information storage unit 220. For example, in response to the internal path provided by the virtual link request reception unit 250 being “shareme/myfile”, the real link generation unit 260 may identify that “shareme” and “myfile” as being a user ID and a sharing ID, respectively, and may search for sharing registration information having “shareme” and “myfile” as a user ID and a sharing ID, respectively, from the sharing registration information storage unit 220. As illustrated in FIG. 7, sharing registration information corresponding to “shareme/myfile” may include “111.222.33.44” as an IP address and “A0404” as a secret key. The real link generation unit 260 may generate a real link, for example, “http://111.222.33.44/myfile”, by combining the IP address and the sharing ID included in the sharing registration information found from the sharing registration information storage unit 220.

In an alternative exemplary embodiment, the real link generation unit 260 may encrypt the sharing ID included in the found sharing registration information with the secret key included in the found sharing registration information, and may generate a real link in the HTTP format by combining the IP address included in the found sharing registration information with the encrypted sharing ID. For example, as illustrated in FIG. 8, in response to the encrypted sharing ID being “bbeeff0201FCK”, the real link generation unit 260 may generate “http://111.222.33.44/bbeeff0201FCK” as a real link.

The redirection unit 270 may transmit redirection information, including the real link generated by the real link generation unit 260, as a response to the access request signal received by the virtual link request reception unit 250. The redirection information may include an HTTP redirection response.

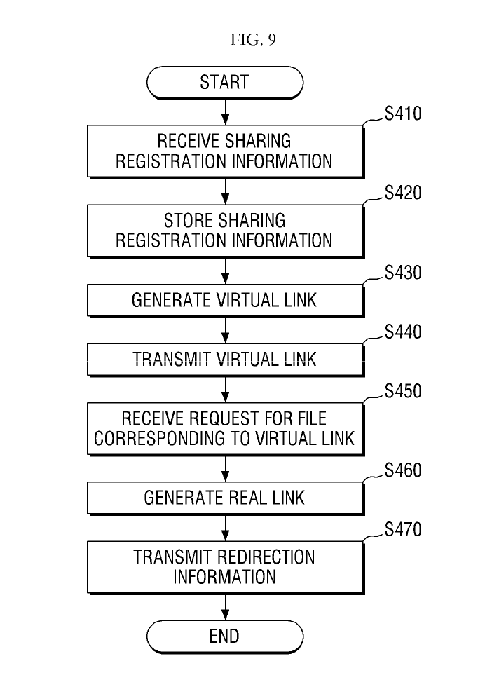

FIG. 9 is a flowchart illustrating the operation of a sharing server, according to an exemplary embodiment of the invention.

The operation of the sharing server 200 will hereinafter be described with reference to FIG. 9.

Referring to FIG. 9, the sharing server 200 receives (S410) sharing registration information.

The sharing server 200 stores (S420) the sharing registration information.

The sharing server 200 generates (S430) a virtual link based on the sharing registration information.

The sharing server 200 transmits (S440) the virtual link as a response to the sharing registration information.

The sharing server 200 receives (S450) an access signal via the virtual link. The access signal may include a request for transmitting a file corresponding to the virtual link.

The sharing server 200 searches for and finds information corresponding to the access signal from the sharing registration information stored in S420 and generates (S460) a real link based on the found information.

The sharing server 200 transmits (S470) redirection information including the real link as a response to the access signal.

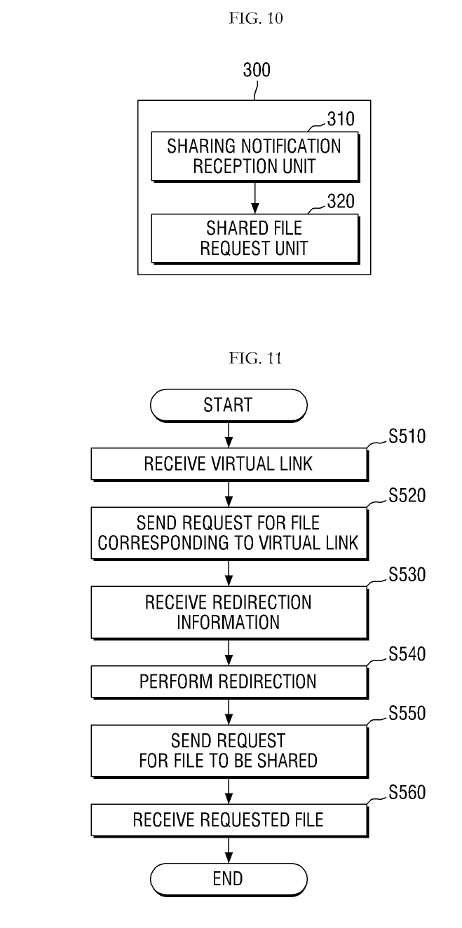

FIG. 10 is a block diagram of a receiver terminal according to an exemplary embodiment of the invention.

The structure and operation of the receiver terminal 300 will hereinafter be described with reference to FIG. 10.

Referring to FIG. 10, the receiver terminal 300 may include a sharing notification reception unit 310 and a shared file request unit 320.

The sharing notification reception unit 310 may receive a virtual link from the transmitter terminal 100. The virtual link may be provided to the shared file request unit 320.

The sharing notification reception unit 310 may receive the virtual link via at least one of email, an SNS and a messaging service, but the invention is not limited thereto.

The shared file request unit 320 may access a server indicated by the virtual link, i.e., the sharing server 200, via the virtual link. The shared file request unit 320 may then send a request for the transmission of a file also indicated by the virtual link to the sharing server 200.

The shared file request unit 320 may receive redirection information including a real link from the sharing server 200.

The shared file request unit 320 may perform redirection. More specifically, the shared file request unit 320 may access the transmitter terminal 100 via the real link included in the redirection information. The shared file request unit 320 may then send a request for the transmission of a file indicated by the real link to the transmitter terminal 100.

The shared file request unit 320 may share a file from the transmitter terminal 100 as a response to the request sent to the transmitter terminal 100.

In an exemplary embodiment, the shared file request unit 320 may share a file from the transmitter terminal 100 via a web browser. The virtual link and the real link may both be HTTP address links. Accordingly, in response to a request being made for a file indicated by the virtual link via the web browser, the web browser makes an inquiry of an IP address corresponding to a domain address included in the virtual link to a DNS server, and receives the IP address corresponding to the domain address included in the virtual link from the DNS server. The web browser accesses the sharing server 200 and sends a request for the transmission of the file indicated by the virtual link to the sharing server 200. The web browser receives redirection information including the real link from the sharing server 200, and accesses the transmitter terminal 100 via the real link. The web browser then sends a request for the transmission of a file indicated by the real link to the transmitter terminal 100, and may share a file from the transmitter terminal 100.

FIG. 11 is a flowchart illustrating the operation of a receiver terminal, according to an exemplary embodiment of the invention.

The operation of the receiver terminal 300 will hereinafter be described with reference to FIG. 11.

Referring to FIG. 11, the receiver terminal 300 receives (S510) a virtual link. The receiver terminal 300 may use at least one of email, an SNS and a messaging service to receive the virtual link, but the invention is not limited thereto.

The receiver terminal 300 accesses (S520) a server indicated by the virtual link to send a request for the transmission of a file also indicated by the virtual link.

The receiver terminal 300 receives (S530) redirection information including a real link from the server indicated by the virtual link.

The receiver terminal 300 redirects (S540) itself to a terminal indicated by the real link via the real link.

The receiver terminal 300 sends (S550) a request for a file also indicated by the real link to the terminal to which the receiver terminal 300 is redirected.

The receiver terminal 300 shares (S560) a file from the terminal to which the receiver terminal 300 is redirected.

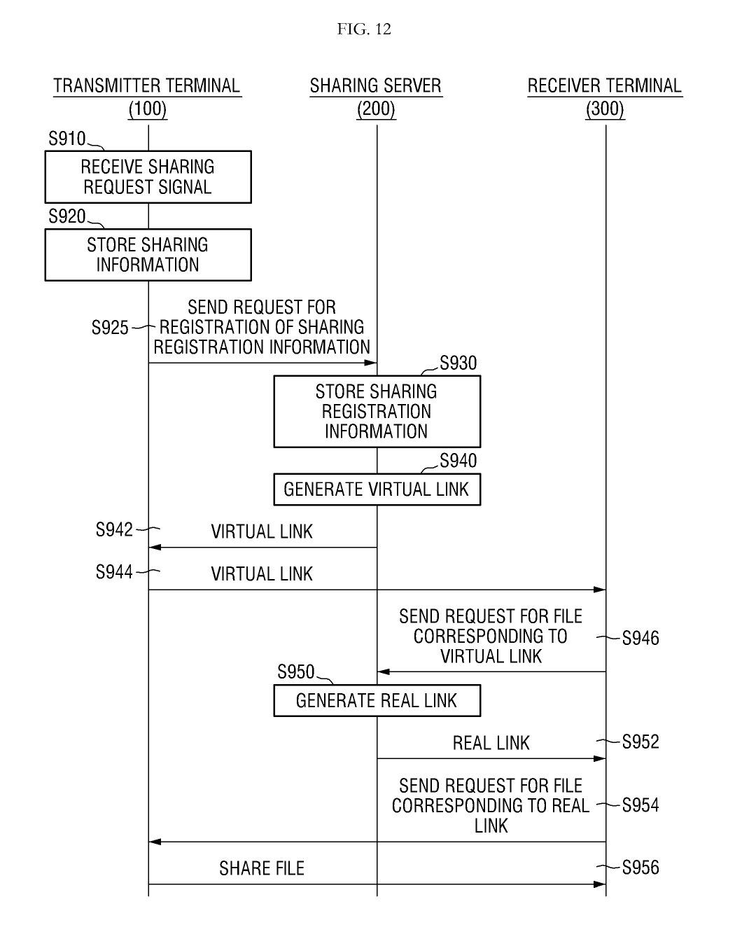

FIG. 12 is a signal flowchart illustrating the transmission of signals or messages between the transmitter terminal, the sharing server and the receiver terminal of a system for sharing files over P2P, according to an exemplary embodiment of the invention.

The transmission of signals between the transmitter terminal 100, the sharing server 200 and the receiver terminal 300 will hereinafter be described with reference to FIG. 12.

Referring to FIG. 12, the transmitter terminal 100 receives (S910) a sharing request signal from the user of the transmitter terminal 100.

The transmitter terminal 100 stores (S920) sharing information included in the sharing request signal. The sharing information may include the sharing ID and the local address of a predetermined file to be shared and a secret key.

The transmitter terminal 100 registers (S925) sharing registration information in the sharing server 200. The sharing registration information may include the user ID and the IP of the transmitter terminal 100, the sharing ID of the predetermined file and the secret key.

The sharing server 200 receives and stores (S930) the sharing registration information.

The sharing server 200 generates (S940) a virtual link by using an arbitrarily-generated domain address and the user ID and the sharing ID included in the sharing registration information.

The sharing server 200 transmits (S942) the virtual link to the transmitter terminal 100.

The transmitter terminal 100 shares (S944) the virtual link to the receiver terminal 300.

The receiver terminal 300 sends (S946) a request for a file indicated by the virtual link, i.e., the predetermined file, to the sharing server 200.

The sharing server 200 receives an access signal via the virtual link, searches for and finds information corresponding to the access signal from the sharing registration information stored in S930, and generates (S950) a real link based on the found information.

The sharing server 200 transmits (S952) redirection information including the real link to the receiver terminal 300.

The receiver terminal 300 sends (S954) a request for the transmission of a file indicated by the real link, i.e., the predetermined file, to the transmitter terminal 100 via the real link.

The transmitter terminal 100 transmits (S956) the predetermined file to the receiver terminal 300.

While the invention has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

What is claimed is:

1. A method of sharing files over Peer-to-Peer (P2P), the method comprising:
transmitting, at a transmitter terminal, sharing registration information for sharing at least one file with another terminal;
receiving, at the transmitter terminal, a virtual link as a response to the sharing registration information;
sharing, at the transmitter terminal, the virtual link;
receiving, at the transmitter terminal, a sharing request signal from a receiver terminal accessing the transmitter terminal via the virtual link; and
transmitting, at the transmitter terminal, the at least one file to the receiver terminal as a response to the sharing request signal.

2. The method of claim 1, further comprising, before the transmitting, at the transmitter terminal, the sharing registration information,
storing, at the transmitter terminal, sharing information, which is information relating to the at least one file,
wherein the transmitting, at the transmitter terminal, the at least one file, comprises:
searching for, at the transmitter terminal, sharing information corresponding to the sharing request signal from the stored sharing information; and
in response to the sharing information corresponding to the sharing request signal being found from the stored sharing information, transmitting, at the transmitter terminal, a file corresponding to the found sharing information as a response to the sharing request signal.

3. The method of claim 2, wherein the sharing information includes a local address and a sharing ID of the at least one file, the local address of the at least one file is a local address indicating where in the transmitter terminal the at least one file is stored, and the sharing ID of the at least one file includes a string of text by which the at least one file can be identified and is used to identify the at least one file.

4. The method of claim 2, wherein the sharing information includes a secret key for authenticating the sharing request signal, the sharing registration information also includes the secret key, and the searching for, at the transmitter terminal, the sharing information corresponding to the sharing request signal, comprises decrypting the sharing request signal with the secret key and searching for sharing information corresponding to the decrypted sharing request signal from the stored sharing information.

5. The method of claim 1, wherein the sharing registration information includes a user identifier (ID) and an Internet Protocol (IP) address of the transmitter terminal and a sharing ID by which the at least one file can be identified, the user ID is an ID by which the user of the transmitter terminal can be identified, the IP address of the transmitter terminal is a unique address allocated to the transmitter terminal on the Internet, and the sharing ID of the at least one file includes a string of text by which the at least one file can be identified and is used to identify the at least one file.

6. The method of claim 1, wherein the sharing, at the transmitter terminal, the virtual link, comprises sharing, at the transmitter terminal, the virtual link via at least one of email, a Social Network Service (SNS) and a messaging service.

7. A method of establishing a connection for sharing files over P2P, the method comprising:
receiving, at a sharing server, sharing registration information for sharing a predetermined file;
storing, at the sharing server, the sharing registration information;
generating, at the sharing server, a virtual link based on the sharing registration information;
transmitting, at the sharing server, the virtual link as a response to the sharing registration information;
receiving, at the sharing server, an access signal via the virtual link;
searching for and finding, at the sharing server, sharing registration information corresponding to the access signal from the stored sharing registration information and generating, at the sharing server, a real link based on the found sharing registration information; and
transmitting, at the sharing server, redirection information including the real link as a response to the access signal.

8. The method of claim 7, wherein the sharing registration information includes a user ID and an IP address of a transmitter terminal from which the predetermined file is to be shared, and a sharing ID by which the predetermined file can be identified.

9. The method of claim 8, wherein the generating, at the sharing server, the virtual link, comprises:
generating, at the sharing server, an arbitrary domain address;
registering, at the sharing server, the domain address and an IP address of the sharing server in a domain name service (DNS) server; and
generating, at the sharing server, the virtual link based on the domain address and the sharing registration information.

10. The method of claim 9, wherein the generating, at the sharing server, the virtual link, further comprises generating the virtual link in a Hyper-Text Transfer Protocol (HTTP) format by combining the domain address, the user ID of the transmitter terminal and the sharing ID.

11. The method of claim 8, wherein the generating, at the sharing server, the real link, comprises generating, at the sharing server, the real link in an HTTP format by combining the IP address of the transmitter terminal and the sharing ID.

12. The method of claim 11, wherein the sharing registration information further includes a secret key and the generating, at the sharing server, the real link, comprises:
encrypting, at the sharing server, the sharing ID with the secret key; and
generating, at the sharing server, the real link in the HTTP format by combining the IP address of the transmitter terminal and the encrypted sharing ID.

13. A method of receiving files over P2P, the method comprising:
sharing, at a receiver terminal, a virtual link;
accessing, at the receiver terminal, a server indicated by the virtual link via the virtual link;
receiving, at the receiver terminal, redirection information from the server;
accessing, at the receiver terminal, a transmitter terminal indicted by a real link included in the redirection information via the real link; and
sharing, at the receiver terminal, a file from the transmitter terminal.

14. A sharing server comprising:
a sharing registration information reception unit configured to receive sharing registration information for sharing a predetermined file;
a sharing registration information storage unit configured to store the sharing registration information;
a virtual link generation unit configured to generate a virtual link based on the sharing registration information;
a virtual link transmission unit configured to transmit the virtual link to the transmitter terminal;
a virtual link request unit configured to receive an access signal via the virtual link;
a real link generation unit configured to search for and find sharing registration information corresponding to the access signal from the sharing registration information storage unit and generates a real link based on the found sharing registration information; and
a redirection unit configured to transmit redirection information including the real link to the transmitter terminal as a response to the access signal.

15. The sharing server of claim 14, wherein the sharing registration information includes a user ID and an IP address of the transmitter terminal and a sharing ID by which the predetermined file can be identified.

16. The sharing server of claim 14, wherein the virtual link generation unit is further configured to generate an arbitrary domain address, register the domain address and an IP address of the sharing server in a DNS server and generate the virtual link based on the domain address and the sharing registration information.

17. The sharing server of claim 15, wherein the real link generation unit is further configured to generate the real link in an HTTP format by combining the IP address of the transmitter terminal and the sharing ID.

18. The sharing server of claim 15, wherein the sharing registration information further includes a secret key and the real link generation unit is further configured to encrypt the sharing ID with the secret key and generate the real link in the HTTP format by combining the IP address of the transmitter terminal and the encrypted sharing ID.

19. A system for sharing files over P2P, the system comprising:
a transmitter terminal;
a sharing server; and
a receiver terminal,
wherein:
the transmitter terminal transmits sharing registration information relating to a predetermined file to be shared to the sharing server, receives a virtual link as a response to the sharing registration information, shares the virtual link to the receiver terminal, and transmits the predetermined file to the receiver terminal in response to receipt of a sharing request signal from the receiver terminal;
the sharing server receives the sharing registration information, generates the virtual link based on the received sharing registration information, transmits the virtual link to the transmitter terminal, and in response to receipt of an access signal from the receiver terminal via the virtual link, searches for and finds sharing registration information corresponding to the access signal from the received sharing registration information, generates a real link based on the found sharing registration information and transmits redirection information including the real link to the receiver terminal; and
the receiver terminal receives the virtual link from the transmitter terminal, accesses the sharing server via the virtual link and thus receives the redirection information from the sharing server, and accesses the transmitter terminal via the real link included in the redirection information and thus shares the predetermined file from the transmitter terminal.
